(19) United States
(12) Patent Application Publication
(10) Pub. No.: US 2005/0172840 A1
(43) Pub. Date: Aug. 11, 2005

(54) Method to get a scaly effect on hides and leather so obtained

(76) Inventors: Riccardo Grieco, S.Croce Sull'Arno (IT); Mitzie Pescini, Castelfranco di Sotto (IT)

Correspondence Address: YOUNG & THOMPSON, 745 SOUTH 23RD STREET, 2ND FLOOR, ARLINGTON, VA, 22202, US

(21) Appl. No.: 10/494,569

(22) PCT Filed: Apr. 29, 2002
(86) PCT No.: PCT/IT02/00280

(30) Foreign Application Priority Data
Nov. 6, 2001 (IT) PI2001A000072

(51) Int. Cl. C14B 1/56; B44C 1/24; B44B 5/00

(52) U.S. Cl. 101/32; 101/4; 69/2

(57) ABSTRACT

The present invention consists of a method able to obtain a scaly effect on any type of hide, so as to resemble a reptile skin. This method reached the desired result by an industrial processing of the product, thanks to a cylinder, containing one or more blades, which runs over the hide stamped in positive, so as to cut and slightly lift at least one part of the relief so obtained.

### TECHNICAL FIELD

The present invention concerns the technical sector relating to the treatment of hides for the realization of articles of clothing, bags, shoes and other accessories. Specifically, it concerns a method able to get a particular aesthetic result on leather, so as to give a “scaly” effect to the treated material.

### BACKGROUND ART

Experts in this field know that the hides, are firstly tanned and possibly coloured, and later subjected to a “stamping” that imprints a particular design on the hide. This stage of the processing consists in pressing over the hide a stamp that has a design on its lower surface, so that when it touches the hide and is decisively pushed down, it imprints the design on the hide.

Said treatments of the hide are known art and permit to get on leather designs, lines and different patterns, but they cannot produce a scaly effect on leather so as to resemble a reptile skin.

As a matter of fact, even when the hide is stamped in the above said way, we can get only a series of reliefs on the material, but not scales, which need some projecting strips of the hide to be cut.

Due to the delicacy and accuracy necessary to fulfil this processing, at present, the only known method for getting a “scale effect” consists in cutting manually some projecting strips of the hide, so as to slightly lift them from the base and get the desired effect. Said system is not only expensive and not practical on an industrial scale, but it has even the relevant drawback of being irregular, not very accurate and needing a great number of hours for its processing. In addition, the effect we get is never homogeneous and therefore the “scale” realized is not very pleasing to look at.

### DISCLOSURE OF INVENTION

This invention principally aims at showing an industrial method used to treat the hide in order to obtain a scaly effect, quickly and cheaply, also keeping the product uniform. We reached this result, according to the invention, adopting the technical solution described in the independent claims. Other characteristics of this invention are the object of dependent claims.

The advantages resulting from the present invention essentially consist of the fact that this method permits to treat the hides, in order to obtain the scaly effect, in an industrial and automated way, without any human manual action on the hide to be treated; that the product we obtain is accurate and uniform; that it's possible to realize scales of different shape, thickness and size; that it's possible to treat any type of hide; that there are no risks for the operator; that the leather so treated never results in possible accidental and undesirable cuts, as it may instead happens when the human works manually on the same hide; that is has a low cost and permits to treat a large number of hides thanks to its speed of processing.

These and further advantages and characteristics of the present invention can be better understood by every expert in this field by reading the following description.

Reduced to its essential structure, a method for getting a scaly effect on tanned and treated leathers, according to the invention, comprises the following phases:
means to imprint a projecting design on the hide, with the positive stamping of the same hide;
means to cut horizontally at least one part of the relief so obtained, with one or more blades, included in a cylinder, which pass over the hide at a prefixed distance and pressure;
means to slightly lift at least one part of the relief cut by the blade(s), with the same blade that, rotating jointly with the cylinder, goes up after the incision, so lifting the hide cut.

Conveniently, the stamping of the hide, which is performed by any known method, is always carried out in positive, i.e. on the front side of the hide, so that some projecting strips cone out, where the desired incision will be made. Said stamping can make designs of any kind, shape and size, according to the effect we want to obtain on the hide, the type of material, its sizes and other factors.

Conveniently, it's possible to use any type of hide, consequently the stamping may have a variable thickness from 0.5 mm and over, according to the desired effect.

Conveniently, in order to use this method, a machine must be provided, containing at least one cylinder having one or more blades joint to its external surface, so that they partly or entirely cover its length and the hide can be cut by the same blades without any need of human action.

Conveniently, the cutting blade is made of steel or other material suitable to cut the hide.

Conveniently, said blade(s) can either consist of a straight longitudinal part, in parallel with the central axis of the cylinder, or of a curve realized on the external body of the same cylinder, starting from a point next to one of its bases and ending in the corresponding opposite point next to the other base.

Conveniently, the sizes of the cylinder and the blade(s) vary according to the type of hide treated and to the desired effect. In a practical example the cylinder can vary its length from 4 cm to 3 m and over, and its diameter can range from 2 cm to 40 cm.

Conveniently, the cylinder makes on the hide a complete rotation or one or more portions of rotation according to the effect we want to obtain.

Conveniently, the incision and the lift of the reliefs in the hide are carried out in a single or both directions, according to the desired effect.

Conveniently, in a practical solution, the hide is transported by means of a conveyor belt under the cylinder, so that when they approach each other, the cylinder turns on itself cutting the hide that is passing under it.

Conveniently, in a different practical solution, the hide is placed on a fixed plane, while the cylinder runs over it on its entire length and cuts and lifts in this way the projecting strips as desired.

Conveniently, it's possible to regulate the distance of the cylinder from the hide to be cut, and the pressure of the blade, by means of a mechanical or electronic device.

Conveniently, the hide, after being treated in the above stated way, is then refined by known methods and prepared for distribution and sale.

In practice, the manufacturing details may, however, vary as regards shape, size, position of elements, and type of materials used, but still remain within the range of the idea proposed as a solution and, consequently, within the limits of the protection granted by this patent for invention.

1. Method for getting a scaly effect on leathers, characterized in that it comprises the following phases:
imprinting of a projecting design on the hide, with the positive stamping of the same hide;
horizontal incision of at least one part of the relief so obtained, with one or more blades, included in a cylinder, which pass over the hide at a prefixed distance and pressure;
lifting of at least one part of the relief cut by the blade(s), with the same blade that, rotating jointly with the cylinder, goes up after the incision, so lifting the hide cut.

2. Method as claimed in claim 1, characterized in that the stamping of the hide is always carried out in positive, i.e. on the front side of the hide, so that some projecting strips come out, where the desired incision will be made, with a thickness ranging from 0.5 mm and over, according to the type of material treated and to the desired effect.

3. Method as claimed in claim 1, characterized in that, in order to be used, a machine must be provided, containing at least one cylinder having one or more blades joint to its external surface, so that they partly or entirely cover its length.

4. Method as claimed in claim 1, characterized in that the cutting blade is made of steel or other material suitable to cut the hide and can either consist of a straight longitudinal part, in parallel with the central axis of the cylinder, or of a curve realized on the external body of the same cylinder, starting from a point next to one of its bases and ending in the corresponding opposite point next to the other base.

5. Method as claimed in claim 1, characterized in that the sizes of the cylinder and/or the blade(s) vary according to the type of hide treated and to the desired effect. In practice, the cylinder can vary its length from 4 cm to 3 m and over, and its diameter can range from 2 cm to 40 cm.

6. Method as claimed in claim 1, characterized in that the cylinder makes on the hide a complete rotation or one or more portions of rotation, in a single or both directions, according to the desired effect.

7. Method as claimed in claim 1, characterized in that the hide may be transported by means of a conveyor belt under the cylinder, so that when they approach each other, the cylinder turns on itself cutting the hide that is passing under it.

8. Method as claimed in claim 1, characterized in that the hide may be placed on a fixed plane, while the cylinder runs over it on its entire length and cuts and lifts in this way the projecting strips as desired.

9. Method as claimed in claim 1, characterized in that it's possible to regulate the distance of the cylinder from the hide to be cut, and the pressure of the blade, by means of a mechanical or electronic device.

10. Method as claimed in claim 1, characterized in that the hide, after being treated in the above stated way, is then refined by known methods and prepared for distribution and sale.

11. Leather that shows on its surface a scaly effect realized with the method as claimed in claim 1.
